(19) United States
(12) Patent Application Publication
(10) Pub. No.: US 2019/0179929 A1
(43) Pub. Date: Jun. 13, 2019

(54) DATA MODIFICATION WITH IDENTIFIERS

(71) Applicant: Hewlett-Packard Development Company, L.P., Houston, TX (US)

(72) Inventors: Kevin Williams, San Diego, CA (US); Amit Kumar Singh, Houston, TX (US); Gaurav Roy, Houston, TX (US)

(21) Appl. No.: 15/839,508

(22) Filed: Dec. 12, 2017

(51) Int. Cl. G06F 17/30

(52) U.S. Cl. CPC G06F 17/30339; G06F 17/30386; G06F 17/30342; G06F 17/30292

(57) ABSTRACT

A system is provided including a memory in communication with a processor. The memory stores data including an entity value of an entity stored in association with an attribute value of an attribute of the entity. The processor stores an entity value identifier in association with an attribute value identifier to obtain modified data. The entity value identifier is associated with the entity value and the attribute value identifier is associated with the attribute value. The processor also transforms the modified data by applying a transformation to the modified data to obtain transformed data. In addition, the processor outputs further modified data from the transformed data, the further modified data including the transformed data with the entity value identifier replaced with the entity value and the attribute value identifier replaced with the attribute value.

### BACKGROUND

Data may be stored in computer-readable databases. These databases may store large volumes of data collected over time. Computers may be used to retrieve and process the data stored in databases.

### BRIEF DESCRIPTION OF THE DRAWINGS

FIG. 1 shows a block diagram of an example computer system.

FIGS. 2A-E show example data tables at various stages of change.

FIG. 3 shows an example data table.

FIGS. 4A-E show other example data tables at various stages of change.

FIGS. 5A-E show other example data tables at various stages of change.

FIG. 6 shows a block diagram of an example computer-readable storage medium.

FIG. 7 shows a flow chart of an example method for modifying, transforming, and further modifying data.

FIG. 8 shows an example data structure.

FIGS. 9A-E show other example data tables at various stages of change.

FIG. 10 shows example stages of storing data in the example data structure of FIG. 8.

### DETAILED DESCRIPTION

Increasing volumes of data create increased complexity when storing, manipulating, and assessing the data. For example, with increases in the connectively of devices and the number of sensors in the various components of each device making time-series measurements, the generated data is increasingly voluminous and complex.

Complexity in retrieving and manipulating datasets may arise from the complex data structures of systems, system components, and component attributes and their corresponding values. In addition, such complexity may arise from the large volumes of data generated by lengthy time-series measurements related to ensembles of numerous systems.

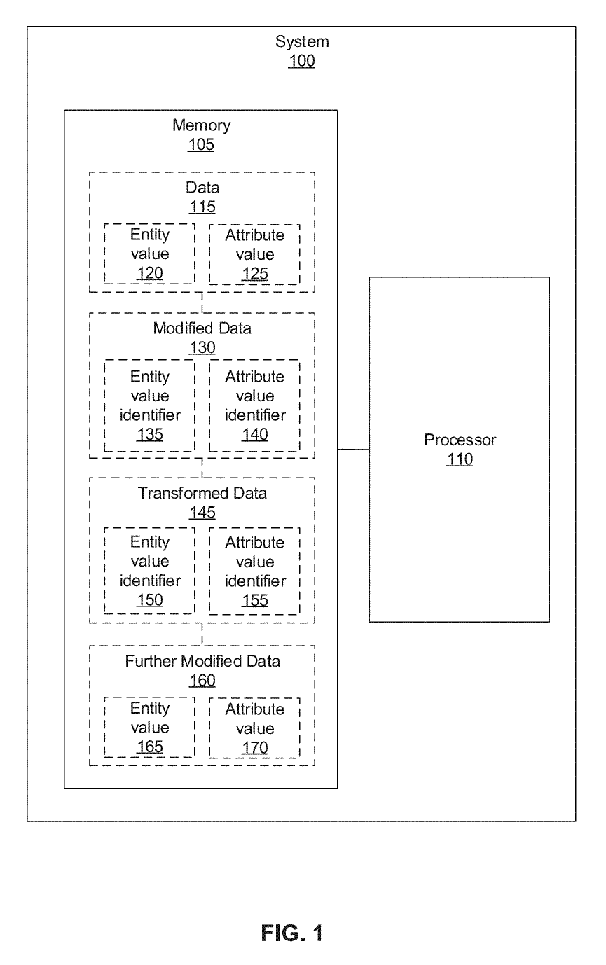

FIG. 1 shows a system 100 which may be used to modify, transform, and further modify data, including large datasets. System 100 comprises a memory 105 in communication with a processor 110. Processor 110 may include a central processing unit (CPU), a graphics processing unit (GPU), a microcontroller, a microprocessor, a processing core, a field-programmable gate array (FPGA), or similar device capable of executing instructions. Processor 110 may cooperate with the memory 14 to execute instructions.

Memory 105 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions. In some example systems, memory 105 may include a database.

Memory 105 is to store data 115 including an entity value 120 of an entity stored in association with an attribute value 125 of an attribute of the entity. Entity value 120 and attribute value 125 may be associated with one another in a suitable manner; for example, entity value 120 and attribute value 125 may be stored in a common row of a data table stored in memory 105.

Processor 110 may store an entity value identifier 135 in association with an attribute value identifier 140 to obtain modified data 130. Entity value identifier 135 may be associated with entity value 120 and attribute value identifier 140 may be associated with attribute value 125. The values and their corresponding identifiers may be associated with one another in a suitable manner; for example, a value and its corresponding identifier may be stored in a common row of a table stored in memory 105 and/or in another data storage.

In addition, processor 110 may transform modified data 130 by applying a transformation to modified data 130 to obtain transformed data 145. Transformed data 145 may include an entity value identifier 150 stored in association with an attribute value identifier 155. In some example systems, entity value identifier 150 may be the same as entity value identifier 135, and attribute value identifier 155 may be the same as attribute value identifier 140. The transformation may be used to condition modified data 130 for subsequent use or processing. For example, if modified data 130 comprises time-series data with missing data points at one or more of the data collection time points, the transformation may comprise filling in the missing data points using imputation and/or other suitable techniques. While imputation to fill in missing time series data points is described herein, it is contemplated that other suitable transformations may be applied to modified data 130 to obtain transformed data 145.

Moreover, processor 110 may output further modified data 160 from transformed data 145. Further modified data 160 may comprise transformed data 145 with entity value identifier 150 replaced with an entity value 165 and attribute value identifier 155 replaced with an attribute value 170. Entity value 165 may be the same as entity value 120, and attribute value 170 may be the same as attribute value 125. This further modification may allow further modified data 160 to be presented in terms of entity and attribute values, similar to data 115.

To output further modified data 160, processor 110 may store further modified data 160 in memory 105 and/or another storage, send further modified data 160 to another component of system 100 or to another system, send further modified data 160 to an output terminal (not shown) of system 100, or the like.

FIG. 1 uses dashed lines to show data 115, modified data 130, transformed data 145, and further modified data 160. The use of dashes lines is intended to indicate that in some example systems each type of data may replace its predecessor in memory 105, while in other example systems two or more of the data types may be stored simultaneously in memory 105, and/or in a combination of memory 105 and other data storage.

In the example where one or more of the data types is replaced by its successor, modified data 130 may replace data 115, whereby entity value identifier 135 may replace entity value 120, and attribute value identifier 140 may replace attribute value 125. Similarly, transformed data 145 may replace modified data 130, and further modified data 160 may replace transformed data 145. These successive replacements may avoid the need to store multiple versions of the data in memory 105, which in turn may yield storage capacity savings when handling datasets. The larger the datasets, the larger will be the storage capacity savings.

The entity and attribute value identifiers may be incrementable. An incrementable identifier may be one where the next identifier may be obtained by incrementing the previous identifier. Incrementable identifiers may be those identifiers where, in order to determine the next identifier to be used, it is not necessary to consult a reference such as a look-up table. A series of incrementable identifiers may be deterministic, in that given an identifier, the next identifier is quickly obtainable. Eliminating or reducing the need to consult a reference to determine the next identifier may reduce the amount of computational resource such as time, energy, working memory; and processing power needed to generate modified data 130 by assigning identifiers to values in data 115. Examples of incrementable identifiers include numbers, such as natural numbers, integers, and the like.

In addition, modifying the data by replacing values with incrementable identifiers prior to the transformation may reduce the amount of memory and other computational resources used to perform the transformation. For example, replacing longer strings of values with relatively shorter natural number identifiers may allow the information to be stored using fewer characters. These fewer characters in turn may require less memory to store, and take up less computational resources during the transformation.

In some example systems, processor 110 may assign to an additional unique entity value a next incremented entity value identifier; and assign to an additional unique attribute value a next incremented attribute value identifier. In this manner, each additional unique entity or attribute value may be assigned an identifier by incrementing the identifier to the next incremented identifier. A unique entity value may be unique among the entity values, and need not be unique when compared to the attribute values. Similarly, a unique attribute value may be unique among the attribute values, and need not be unique when compared to the entity values.

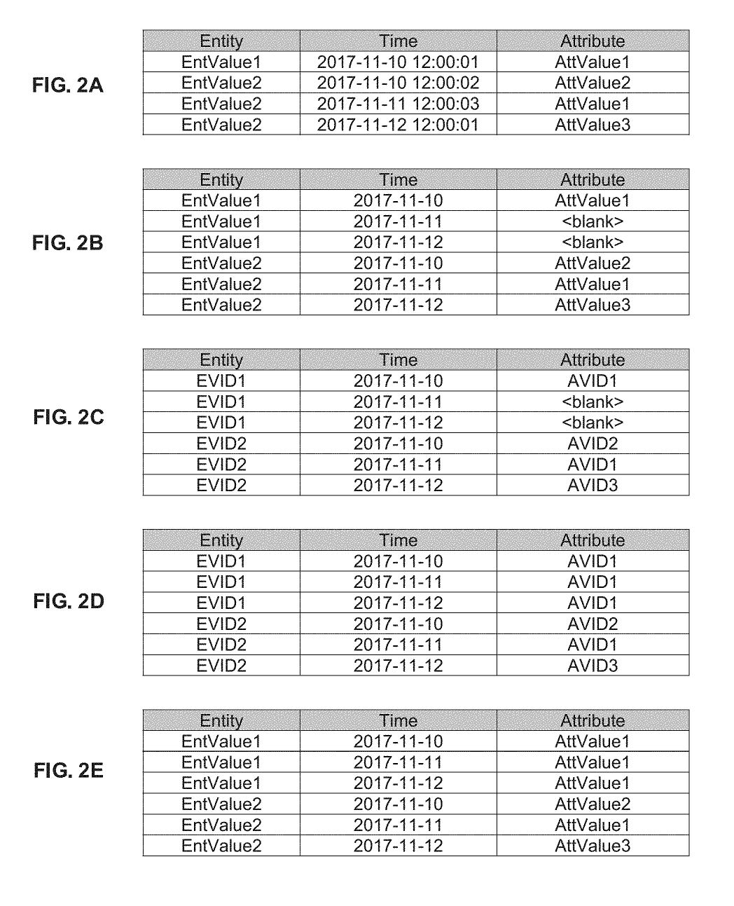

The size of the increment may be predetermined; for example, natural number identifiers may be incremented by 1, real number identifiers may be incremented by 0.1, and the like. Examples of assigning identifiers to additional entity and attribute values are shown in FIGS. 2, 4, and 5, which are discussed in greater detail below.

Moreover, in some example systems, data 115 further comprises a time value stored in association with attribute value 125 and entity value 120. To obtain modified data 130, processor 110 may apply a time transformation to the time value to generate a modified time value, and store the modified time value in association with entity value identifier 135 and attribute value identifier 140.

This type of time transformation may condition the time value for further use or processing of the data. An example of such a time transformation may include truncating or removing characters from the time value, which may in turn reduce the amount of storage or other computational resources needed to handle the time values. When the time value comprises a date, the time transformation may comprise converting the date into a format having a precision of one day. Examples of time transformations are shown in FIGS. 2, 4, and 5, which are discussed in greater detail below.

In some example systems, data 115 may comprise entity value 120 and attribute value 125 stored in association with a latest time value. Data 115 may further comprise a further entity value and a corresponding further attribute value stored in associate with a further latest time value. The further latest time value may be later than the latest time value by a data collection time point. To obtain transformed data 145, processor 110 may, for the data collection time point, store an imputed entity value identifier in association with an imputed attribute value identifier. The imputed entity value identifier may be associated with an imputed entity value and the imputed attribute value identifier may be associated with an imputed attribute value corresponding to the imputed entity value.

When data 115 includes time values, i.e. when data 115 is in the form of a time-series data which has missing data points, imputation may be used to fill in the missing data points in the time series data. Examples of time imputation are shown in FIGS. 2, 4, and 5, which are discussed in greater detail below.

In some example systems, data 115 may further comprise an additional entity value of the entity stored in association with an additional attribute value. In data 115, entity value 120 and attribute value 125 may be stored in association with a time point in a row of a data table. Moreover, the additional entity value and the additional attribute value may be stored in association with the time point in another row of the data table. In further modified data 160, attribute value 170 and the additional attribute value are stored in a given row of a modified data table, the given row further containing the time point, entity value 165, and the additional entity value. Entity value 120 may be the same as entity value 165, and attribute value 125 may be the same as attribute value 170.

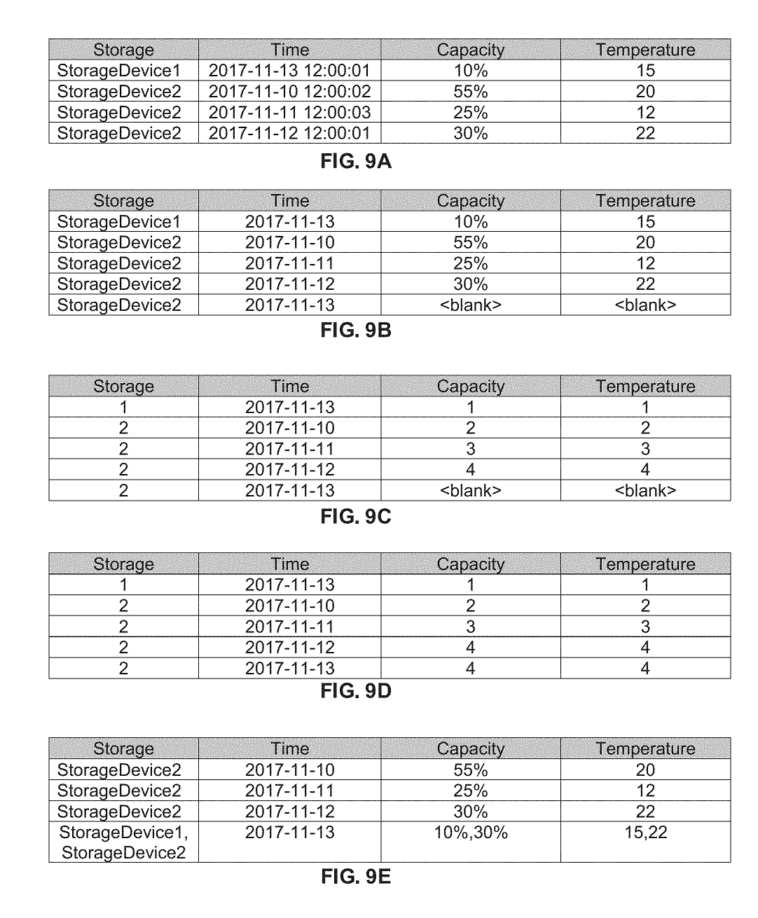

Combining multiple rows of the data table associated with the same data collection time point on one row may reduce the number of rows that need to be reviewed in order to assess and draw a conclusion from the data relating to a given time point. An example of this combining of rows is shown in FIG. 9E, which is discussed in greater detail below.

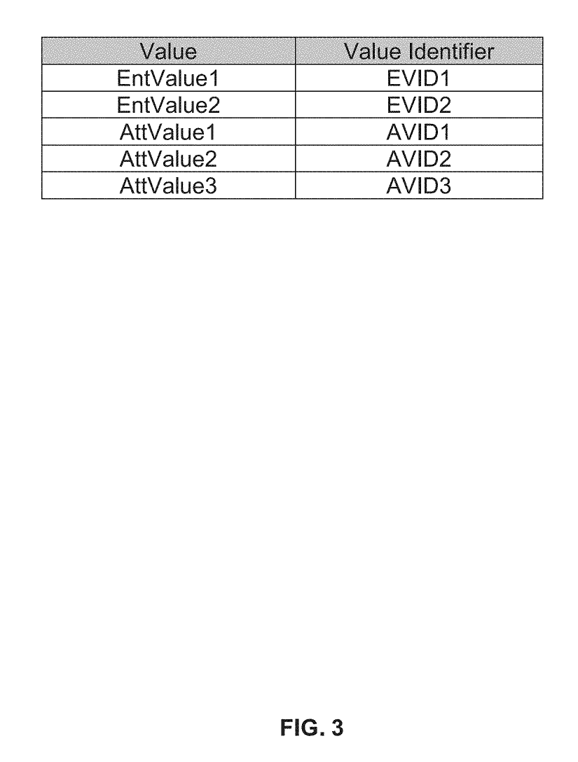

In addition, in some example systems processor 110 may, before modifying data 115 to generate modified data 130, store entity value identifier 135 in association with entity value 120, and attribute value identifier 140 in association with attribute value 125. Keeping a record of the associations between the values and their corresponding identifiers may allow replacement of the identifiers of transformed data 145 with their corresponding values to generate further modified data 160. An example of a data table storing the values in association with their identifiers is shown in FIG. 3, which is discussed in greater detail below. It is contemplated that schemes and data structures other than a table may also be used to store the values in association with their identifiers.

In some example systems, processor 110 may assess attribute value 170 in further modified data 160 using a predetermined criterion. This assessment may be used to draw conclusions from modified data 160. An example of such an assessment is described in relation to FIG. 9E, which is discussed below.

Some example systems may be implemented using Apache™ SPARK and Apache™ HADOOP™ within a custom Scala 2.x application that integrates with Amazon™ Redshift and Amazon™ EMR. In these example systems the Amazon™ Redshift database may be used to store the initial data and/or one or more of the modified, transformed, and further modified versions of the data. Amazon™ Redshift JDBC client may be used to provide communication to and from the Amazon™ Redshift database.

FIGS. 2A-E show an example time-series dataset undergoing the modifications, transformations, and further modifications described herein. FIGS. 2A-E may also be referred to collectively as FIG. 2. FIG. 2A shows entity values stored in association with attribute values and data collection time points, in corresponding rows of a data table. For example, entity value EntValue1 is stored in association with attribute value AttValue1 and data collection time point 2017-11-10 12:00:01. Moreover, FIG. 2A shows that EntValue1 has only one attribute value collected on November 10, while EntValue2 has attribute values collected on November 10, 11, and 12.

FIG. 2B shows two changes to the data shown in FIG. 2A: first, a time transformation is applied to modify the time value associated with the entity and attribute values to generate a modified time value. In this example, the time transformation comprises truncating the time value by removing the time-of-day information, such that the resulting time value has a precision of one day. The modified time values are then stored in the table in association with the entity and attribute values.

The removal of the time-of-day information from the time value reduces the number of characters needed to store the time value, which in turn may reduce the amount of memory and other computational resources used during the subsequent transformation of the data.

It is contemplated that in other examples, a different suitable time transformation may be applied, and that the transformed time value may have a precision other than one day.

The second change to the data shown in FIG. 2B is that new rows for EntValue1 are added for the dates November 11 and 12, where EntValue1 was missing time series data points in comparison to EntValue2, which has data points for November 10-12. In other words, the latest time value for EntValue2 is initially November 12, which is two data collection time points, i.e. 2 days, later than the latest time value for EntValue1 on November 10. For each of these two data collection time points, a new row is added for EntValue1. In FIG. 2B, the attribute value associated with the two added EntValue1 rows is blank.

In FIG. 2C, the data is modified by replacing the entity and attribute values with corresponding value identifiers. For example, in the modified data, entity value EntValue1 is replaced by the entity value identifier EVID1, and the attribute value AttValue1 is replaced by the attribute value identifier AVID1. For EntValue1, the attribute value identifiers on November 11 and 12 remain blank.

Referring to FIGS. 2B and 2C, it can be seen that there are three different attribute values associated with EntValue2. When the data is modified by assigning identifiers to the attribute values, each additional unique attribute value may be assigned the next incremented attribute value identifier. For example, AttValue1 is assigned the identifier AVID1, AttValue2 is assigned the identifier AVID2, and AttValue3 is assigned the identifier AVID3. Similarly, each additional unique entity value may be assigned the next incremented attribute value identifier.

FIG. 2D represents transformed data obtained by applying a transformation to the modified data of FIG. 20. The example transformation shown in FIG. 2D is a last-observation-carried-forward imputation used to fill in the attribute values, and their corresponding identifiers, for EntValue1 on November 11 and 12. Since the latest recorded value for EntValue1, and its corresponding identifier EVID1, is AttValue1 corresponding to AVID1, AVID1 is carried forward to fill in the missing EntValue1 data points on November 11 and 12. A similar type of imputation may be used to impute EntValue1 to the entity values for November 11 and 12. Eliminating or reducing these gaps in the time series data may condition the data for later use and processing.

FIG. 2E shows further modified data obtained by further modifying the transformed data of FIG. 2D. In FIG. 2E, each identifier is replaced by its corresponding value: for example, EVID1 is replaced by EntValue1 and AVID1 is replaced by AttValue1. In this manner, the further modified data in FIG. 2E may be represented in terms of the same or similar entity and attribute values as the initial data shown in FIG. 2A.

Once the data is transformed and further modified, the attribute values in FIG. 2E may be subjected to assessments using a predetermined criterion to obtain information and/or conclusions from the data shown in FIG. 2E. An example of such an assessment is described in relation to FIG. 9E, discussed below.

FIG. 3 shows a data table storing entity value identifiers in association with their corresponding entity values and the attribute value identifiers in association with their corresponding attribute values, for the values and identifiers of FIGS. 2A-E. Storing the identifiers in association with their corresponding values may be performed before the modified data is generated. Having the associations between the identifiers and their corresponding values stored may be used during the generation of the further modified data to allow the identifiers in the transformed data to be replaced with their corresponding values to generate the further modified data.

While FIG. 3 shows a table storing the values in association with their identifiers, it is also contemplated that other suitable schemes may be used to preserve and/or store the association between the values and their corresponding identifiers.

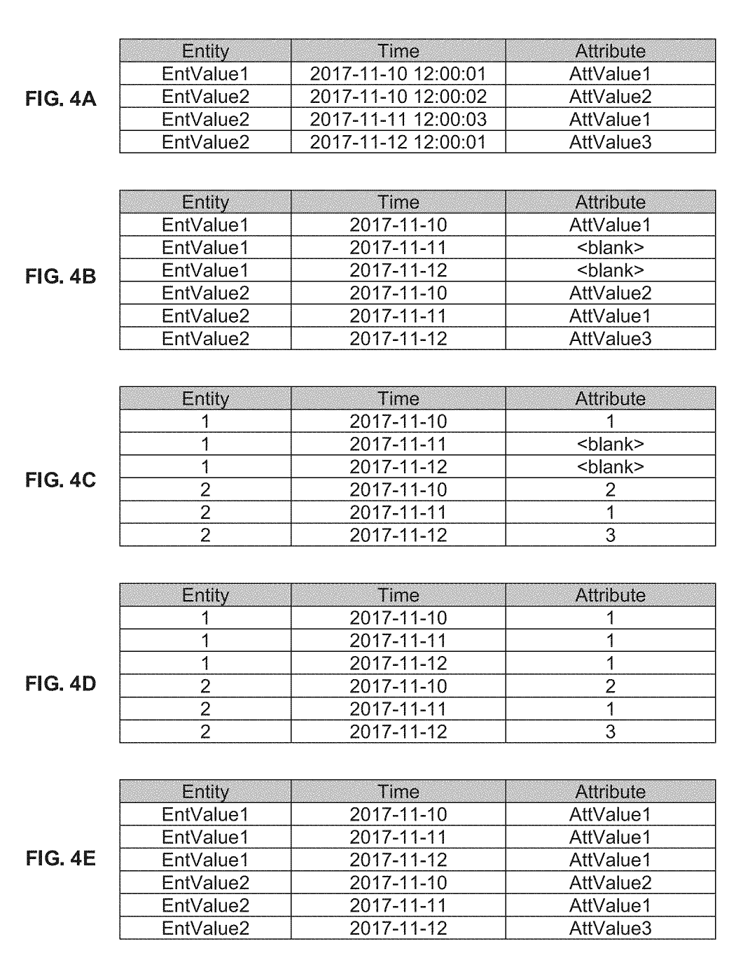

FIGS. 4A-E show another example time-series dataset undergoing the modifications, transformations, and further modifications described herein. FIGS. 4A-E may also be referred to collectively as FIG. 4. FIGS. 4A-E are generally similar to FIGS. 2A-E, with the difference being that natural numbers are used as the identifiers in FIGS. 4A-E. Referring to FIG. 4C, the modified data is obtained by replacing EntValue1 with identifier ‘1’. The next unique entity value, EntValue2, is assigned the next incremented identifier ‘2’.

Similarly, AttValue1 is assigned identifier ‘1’. The next unique attribute value AttValue2 is assigned the next incremented identifier ‘2’. Moreover, the next unique attribute value AttValue3 is assigned the next incremented identifier ‘3’. It can be seen that replacing value strings, e.g. EntValue1 and AttValue1, with shorter natural number identifiers, e.g. ‘1’, may reduce the amount of storage needed to store the modified data and the amount of computational resources needed to transform the modified data.

While not shown in the drawings, it is contemplated that FIGS. 4A-E may be accompanied by a correlation table similar to the one shown in FIG. 3. In some examples, such a correlation table may also include in each row a description of the type of information stored in that row. For example, the rows of the table storing entity values and entity value identifiers may include a description or other indication indicating that the information stored in that row relates to entity values. Similar description may be added for attribute values.

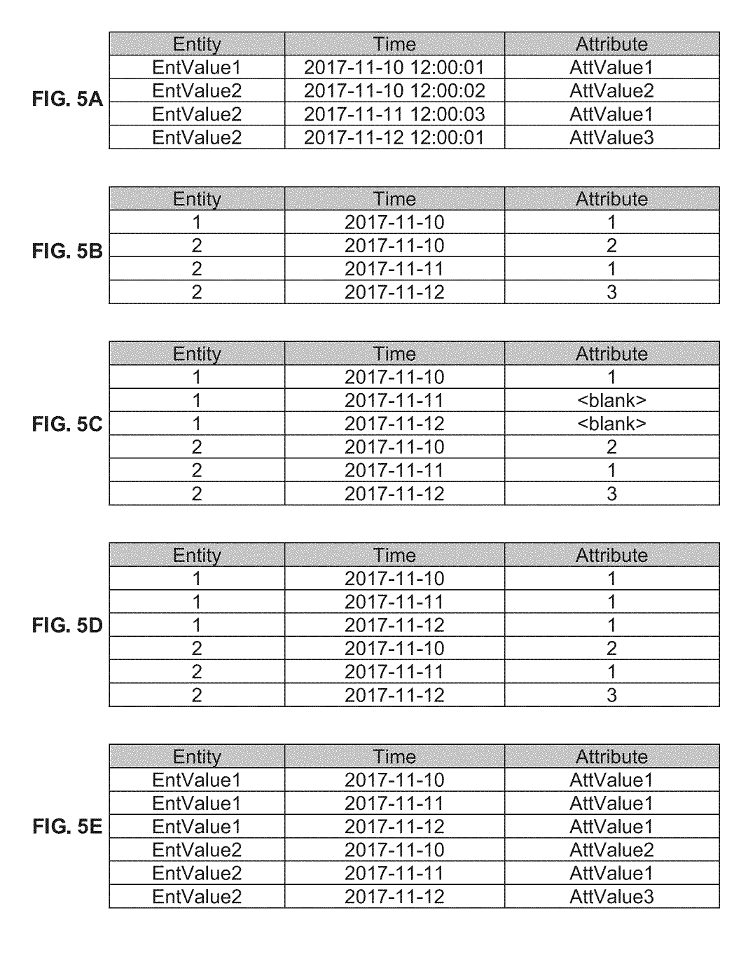

FIGS. 5A-E show another example time-series dataset undergoing the modifications, transformations, and further modifications described herein. FIGS. 5A-E may also be referred to collectively as FIG. 5. FIGS. 5A-E are generally similar to FIGS. 2A-E, with the main difference being that in FIGS. 5A-E, the data is modified in FIG. 5B by replacing values with identifiers before the missing data points in the time series are identified in FIG. 5C. In this manner, the identification of the missing data points also takes place using identifiers, instead of values.

As discussed above, manipulating and/or transforming the modified data comprising identifiers may use less memory and/or other computational resources than using the original data comprising values. As such, performing the identification of missing data points using identifiers as shown in FIGS. 5A-E may reduce the memory or computational resources used when compared to modifying the data after identifying the missing data points as shown in FIGS. 2A-E.

FIG. 5A shows data comprising entity values and their associated attribute values. FIG. 5B represents the modified data, where the values are replaced by their corresponding identifiers. FIGS. 5C-D represent the transformed data generated by identifying missing time-series data points in the modified data and filling in the missing data points using last-observation-carried-forward imputation. Moreover, FIG. 5E represents the further modified data generated by replacing the identifiers in the transformed data with their corresponding entity and attribute values.

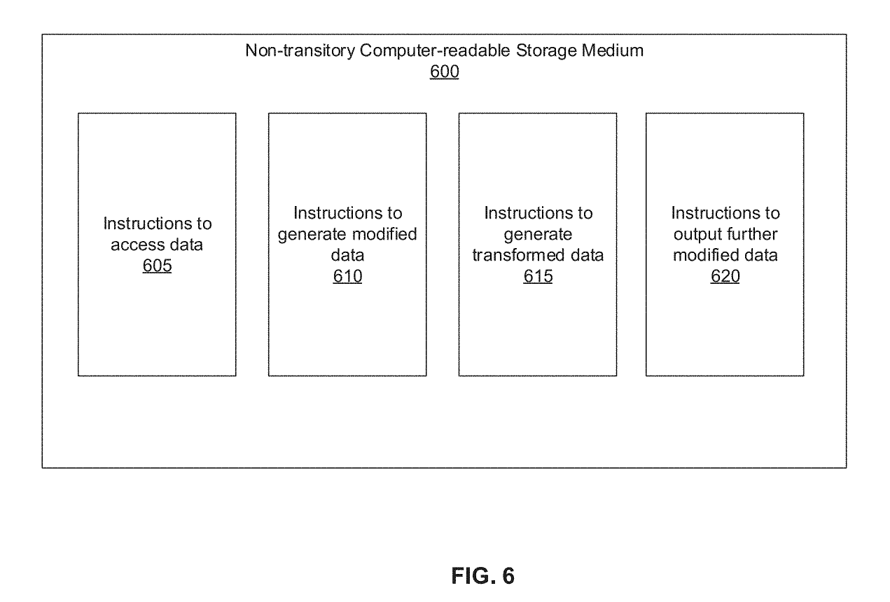

Turning now to FIG. 6, a non-transitory computer-readable storage medium (CRSM) 600 is shown, which comprises instructions executable by a processor. The CRSM may comprise an electronic, magnetic, optical, or other physical storage device that stores executable instructions. The instructions may comprise instructions to cause the processor to access data 605, instructions to generate modified data 610, instructions to generate transformed data 615, and instructions to output further modified data 620. Instructions 605, 610, 615, and 620 may comprise various modules and/or portions of a set of instructions stored on CRSM 600.

Instructions to access data 605 may comprise instructions to cause the processor to access data comprising an entity value of an entity stored in association with an attribute value of an attribute of the entity. Moreover, instruction to generate modified data 610 may comprise instructions to cause the processor to generate modified data by replacing in the data the entity value with an entity value identifier and the attribute value with an attribute value identifier. The entity value identifier and the attribute value identifier may be incrementable.

Furthermore, instructions to generate transformed data 615 may comprise instructions to cause the processor to generate transformed data by applying a transformation to the modified data. Instructions to output further modified data 620, in turn, may comprise instructions to cause a processor to output further modified data by replacing in the transformed data the entity value identifier with the entity value and the attribute value identifier with the attribute value.

CRSM 600, and the instructions stored therein, may cause a processor to perform a selection of or all of the functions described therein.

In some example CRSMs, the instructions may further case the processor to, before the modified data is generated, store the entity value identifier in association with the entity value and the attribute value identifier in association with the attribute value.

Furthermore, in some example CRSMs, to generate the modified data, the instructions may further cause the processor to replace an additional unique entity value with a next incremented entity value identifier and replace an additional unique attribute value with a next incremented attribute value identifier. The entity value identifier and the attribute value identifier may comprise natural numbers.

Moreover, in some example CRSMs, the data may comprise the entity value and the attribute value stored in association with a latest time value. The data may further comprise a further entity value and a corresponding further attribute value stored in associate with a further latest time value. The further latest time value may be later than the latest time value by a data collection time point. Furthermore, to generate the transformed data, the instructions may cause the processor to, for the data collection time point, store an imputed entity value identifier in association with an imputed attribute value identifier. The imputed entity value identifier may be associated with an imputed entity value, and the imputed attribute value identifier may be associated with an imputed attribute value corresponding to the imputed entity value.

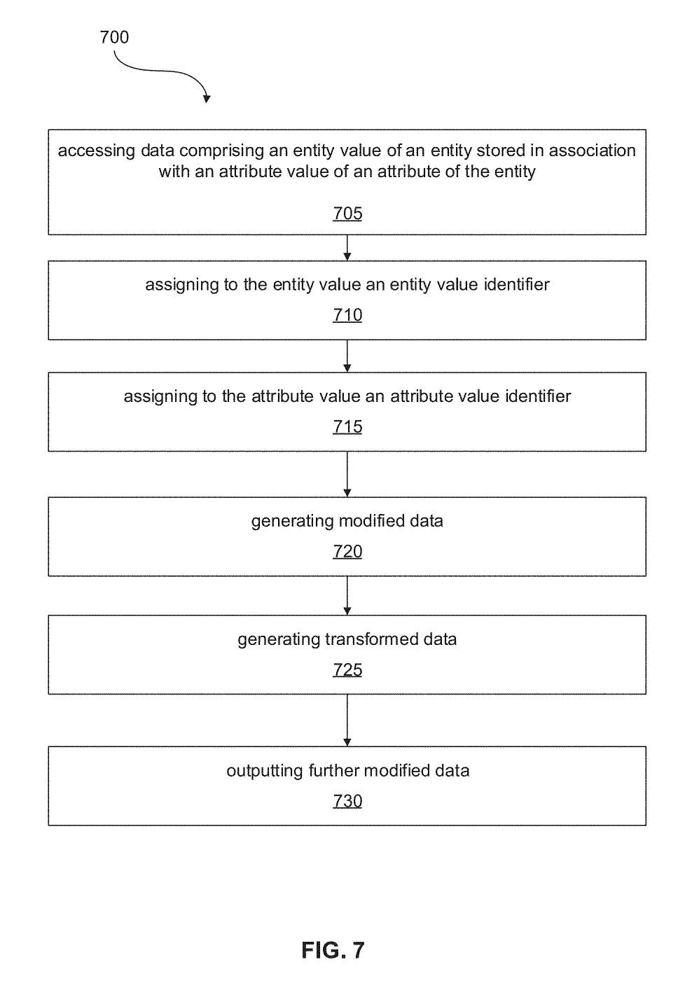

FIG. 7 shows a flowchart of a method 700 for modifying, transforming, and further modifying data. Box 705 includes accessing data comprising an entity value of an entity stored in association with an attribute value of an attribute of the entity. Box 710 includes assigning to the entity value an entity value identifier, and box 715 includes assigning to the attribute value an attribute value identifier. The entity value identifier and the attribute value identifier may be incrementable. In some examples, the entity value identifier and the attribute value identifier may comprise natural numbers.

Moreover, box 720 includes generating modified data. The modified data may be generated by storing the entity value identifier in association with the attribute value identifier. Box 725, in turn, includes generating transformed data, which may be generated by applying a transformation to the modified data. Furthermore, box 730 includes outputting further modified data. The outputting the further modified data may include replacing in the transformed data the entity value identifier with the entity value and the attribute value identifier with the attribute value.

In some examples, method 700 may further include a selection of or all of the features and/or functions described therein. For example, method 700 may further include assigning to an additional unique entity value a next incremented entity value identifier and assigning to an additional unique entity value a next incremented entity value identifier. Examples of assigning next incremented identifiers have been discussed in relation to FIGS. 1-5.

Furthermore, in some examples of method 700, the data may further comprise a time value stored in association with the attribute value and the entity value. The generating the modified data of box 720 may comprise: generating a modified time value by applying a time transformation to the time value, and storing the modified time value in association with the entity value identifier and the attribute value identifier. The time value may comprise a date, and the time transformation may comprise converting the date into a format having a precision of one day. Examples of time transformations have been discussed in relation to FIGS. 1-5.

In addition, in some examples of method 700, the data may comprise the entity value and the attribute value stored in association with a latest time value. Moreover, the data may further comprise a further entity value and a corresponding further attribute value stored in associate with a further latest time value, the further latest time value being later than the latest time value by a data collection time point. In such a case, the generating the transformed data may comprise: for the data collection time point, storing an imputed entity value identifier in association with an imputed attribute value identifier. The imputed entity value identifier may be associated with an imputed entity value and the imputed attribute value identifier may be associated with an imputed attribute value corresponding to the imputed entity value. The imputed entity value and the imputed attribute value may be generated using a last observation carried forward imputation. Examples of such imputations have been discussed in relation to FIGS. 1-5.

In some examples, method 700 may further comprise assessing the attribute value in the further modified data using a predetermined criterion. Examples of such assessments have been discussed in relation to FIGS. 2E and 9E.

Moreover, in some examples of method 700, the data may further comprise an additional entity value of the entity stored in association with an additional attribute value. In the data, the entity value and the attribute value may be stored in association with a time point in a row of a data table, and the additional entity value and the additional attribute value may be stored in association with the time point in another row of the data table. In the further modified data, the attribute value and the additional attribute value may be stored in a given row of a modified data table. The given row may further contain the time point, the entity value, and the additional entity value. An example of storing modified data on a given row is discussed in relation to FIG. 9E.

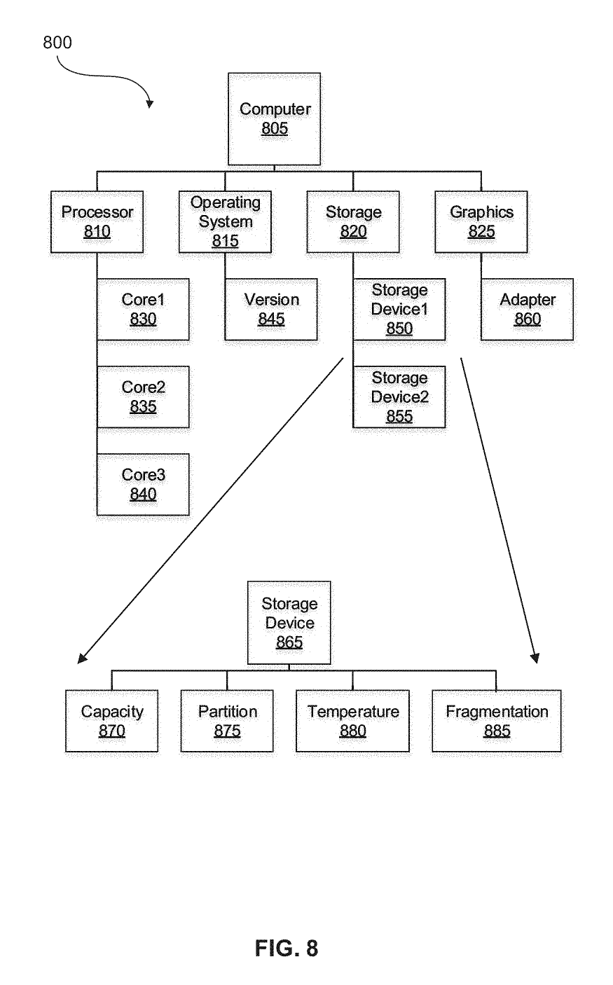

Referring now to FIG. 8, an example data structure 800 is shown. Data structure 800 comprises data related to a computer 805, for which data is recorded relating to its processor 810, operating system 815, storage 820, and graphics 825. Processor 810 may comprise core1 830, core2 835, and core3 840. Moreover, version 845 may be recoded in relation to operating system 815.

Storage 820 may comprise StorageDevice1 850 and StorageDevice2 855. Furthermore, information relating to adapter 860 may be recoded in association with graphics 825. FIG. 8 also shows that each storage device 865 may have recoded, in relation to it, capacity 870, partition 875 information, temperature 880, and fragmentation 885 information. Storage device 865 may include StorageDevice1 850 or StorageDevice2 855. When time-series data is collected, all or a part of data structure 800 may be recorded for each data collection time point.

While FIGS. 8-10 show data structure 800 relating to computer 805, it is contemplated that the functions and features described herein may apply to different data structures relating to different subject matter.

FIGS. 9A-E show another example time-series dataset undergoing the modifications, transformations, and further modifications described herein. FIGS. 9A-E may also be referred to collectively as FIG. 9. The dataset shown in FIGS. 9A-E is related to a portion of the data structure 800: namely, the dataset shown in FIGS. 9A-E includes data relating to storage devices and their capacity and temperature.

FIG. 9A shows the original data. This data may be generated by computer 805, and/or its components and sensors, capturing the data and then saving it to storage, which storage may comprise a database. In order to prepare the data for the modification, transformation, and further modifications shown in FIGS. 9B-E, the stored data may be retrieved. If the data is stored in a structure other than its structure as reflected in FIG. 8 and FIG. 9A, upon retrieval the data may be reassembled into its data structure before the data is changed starting in FIG. 9B.

The changes to the data shown in FIGS. 9B-D are generally similar to the changes shown in FIGS. 2 and 4. In FIG. 9B a time transformation is applied to the time values to truncate the time values by removing the time-of-day information. This time transformation converts the time values to corresponding dates having the precision of one day.

Moreover, in FIG. 9B gaps in the time series data are identified. These gaps may comprise missing data points. In contrast to FIGS. 2 and 4, in FIGS. 9B-D transforming the time-series data may allow for StorageDevice1 and StorageDevice2 to both have capacity and temperate data points on the latest date on which either one of StorageDevice1 and StorageDevice2 has those data points. In this case, StorageDevice1 has data points on November 13, but StorageDevice2 does not. As such, a data point for StorageDevice2 is added on November 13, and its corresponding capacity and temperature values are indicated as <blank>.

In FIG. 9C the data is modified by replacing the storage, capacity, and temperature values with natural number identifiers. In FIG. 9D, the modified data is transformed using last-observation-carried-forward imputation to fill in the missing data points for StorageDevice2 on November 13.

Furthermore, in FIG. 9E the transformed data is further modified by replacing the identifiers with their corresponding storage, capacity, and temperature values. FIG. 9E is different from FIGS. 2E, 4E, and 5E in that in FIG. 9E, for November 13, which is the date for which both StorageDevice1 and StorageDevice2 have data points in the transformed data, the data is combined on one row of the table, and values are comma separated. The order of the comma separated values in each cell may be maintained to reflect which of capacity and temperate values corresponds to which one of the storage devices. In other examples, the values that are combined on the same row may be separated using a separator other than a comma. In yet other examples, the values that are combined on the same row may be stored in different cells on the same row.

Combining data values for a given date on the same row may allow for assessing the system according to a predetermined criterion to obtain a conclusion about the system on the given date. For example, the given criterion may be that storage capacity for a storage device being below 20% indicates that the system is unhealthy.

For November 13, assessing the health of the system may comprise determining the smallest value in the capacity cell of the data table in FIG. 9E. If the smallest value is below 20%, then the system is determined to be unhealthy. In some examples, a determination that the system is unhealthy may cause an audio, visual, and/or tactile notification to be generated. Combining the values for November 13 on one row may allow an assessment of system health based on storage capacity to review the contents of one cell. In contrast, without the data being combined a similar assessment would require reviewing two separate cells on two separate rows, one for each of StorageDevice1 and StorageDevice2. Reducing the number of cells that need to be reviewed for each assessment may reduce the amount of time and other computational resources used for performing the assessment.

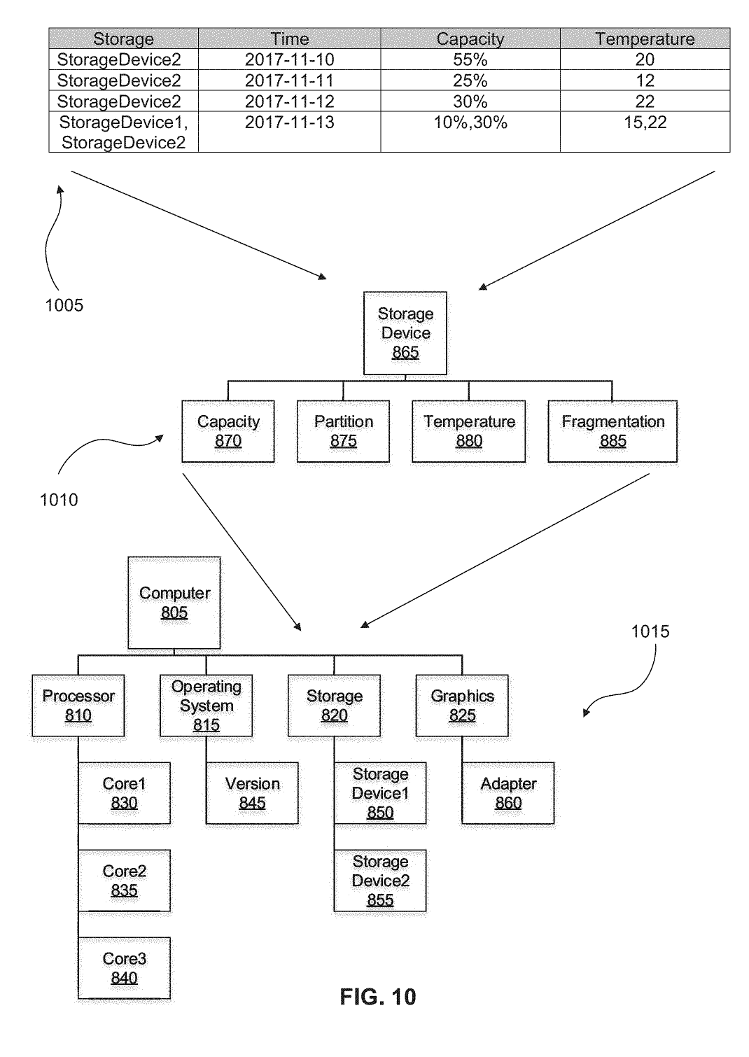

FIG. 10 shows a further modified data table 1005, which is the same as the data table shown in FIG. 9E. Data table 1005 may be stored back into a portion 1010 of the data structure 800, shown in FIG. 8. Portion 1010 may, in turn, be stored back into portion 1015 of data structure 800. In this manner, the modifications, transformations, and further modifications described herein may leave the structure of the data substantially intact. This, in turn, may allow the data to substantially retain its structure throughout the modification, transformation, and further modification.

After the assessment of the further modified data is completed, the further modified data may be stored in the database for later reference and/or processing.

The systems, CRSMs, and methods described herein may include the features and/or perform the functions described herein in association with one or a combination of the other systems, CRSMs, and methods described herein.

The systems, CRSMs, and methods described herein may allow large datasets to be manipulated and/or conditioned using reduced memory and/or other computational resources. Moreover, datasets with complex data structures may be transformed, conditioned, and/or assessed while allowing the data to be reassembled into substantially its original data structure.

It should be recognized that features and aspects of the various examples provided above may be combined into further examples that also fall within the scope of the present disclosure.

1. A method comprising:
accessing data comprising an entity value of an entity stored in association with an attribute value of an attribute of the entity;
assigning to the entity value an entity value identifier that is incrementable;
assigning to the attribute value an attribute value identifier that is incrementable;
generating modified data by storing the entity value identifier in association with the attribute value identifier;
generating transformed data by applying a transformation to the modified data; and
outputting further modified data by replacing in the transformed data the entity value identifier with the entity value and the attribute value identifier with the attribute value.

2. The method of claim 1, further comprising:
assigning to an additional unique entity value a next incremented entity value identifier; and
assigning to an additional unique attribute value a next incremented attribute value identifier.

3. The method of claim 1, wherein the entity value identifier and the attribute value identifier comprise natural numbers.

4. The method of claim 1, wherein:
the data further comprises a time value stored in association with the attribute value and the entity value; and
the generating the modified data comprises:
generating a modified time value by applying a time transformation to the time value; and
storing the modified time value in association with the entity value identifier and the attribute value identifier.

5. The method of claim 4, wherein:
the time value comprises a date; and
the time transformation comprises converting the date into a format having a precision of one day.

6. The method of claim 1, wherein:
the data comprises the entity value and the attribute value stored in association with a latest time value;
the data further comprises a further entity value and a corresponding further attribute value stored in associate with a further latest time value, the further latest time value being later than the latest time value by a data collection time point; and
the generating the transformed data comprises:
for the data collection time point, storing an imputed entity value identifier in association with an imputed attribute value identifier, the imputed entity value identifier associated with an imputed entity value and the imputed attribute value identifier associated with an imputed attribute value corresponding to the imputed entity value.

7. The method of claim 6, wherein the imputed entity value and the imputed attribute value are generated using a last observation carried forward imputation.

8. The method of claim 1, further comprising assessing the attribute value in the further modified data using a predetermined criterion.

9. The method of claim 1, wherein:
the data further comprises an additional entity value of the entity stored in association with an additional attribute value;
in the data:
the entity value and the attribute value are stored in association with a time point in a row of a data table; and
the additional entity value and the additional attribute value are stored in association with the time point in another row of the data table; and
in the further modified data, the attribute value and the additional attribute value are stored in a given row of a modified data table, the given row further containing the time point, the entity value, and the additional entity value.

10. A system comprising:
a memory to store data comprising an entity value of an entity stored in association with an attribute value of an attribute of the entity;
a processor in communication with the memory, the processor to:
store an entity value identifier in association with an attribute value identifier to obtain modified data, the entity value identifier associated with the entity value and the attribute value identifier associated with the attribute value;
transform the modified data by applying a transformation to the modified data to obtain transformed data; and
output further modified data from the transformed data, the further modified data comprising the transformed data with the entity value identifier replaced with the entity value and the attribute value identifier replaced with the attribute value.

11. The system of claim 10, wherein the entity value identifier and the attribute value identifier are incrementable.

12. The system of claim 11, wherein the processor is further to:
assign to an additional unique entity value a next incremented entity value identifier; and
assign to an additional unique attribute value a next incremented attribute value identifier.

13. The system of claim 10, wherein:
the data further comprises a time value stored in association with the attribute value and the entity value; and
to obtain the modified data, the processor is further to:
apply a time transformation to the time value to generate a modified time value; and
store the modified time value in association with the entity value identifier and the attribute value identifier.

14. The system of claim 10, wherein:
the data comprises the entity value and the attribute value stored in association with a latest time value;
the data further comprises a further entity value and a corresponding further attribute value stored in associate with a further latest time value, the further latest time value being later than the latest time value by a data collection time point; and
to obtain the transformed data, the processor is further to:
for the data collection time point, store an imputed entity value identifier in association with an imputed attribute value identifier, the imputed entity value identifier associated with an imputed entity value and the imputed attribute value identifier associated with an imputed attribute value corresponding to the imputed entity value.

15. The system of claim 10, wherein:
the data further comprises an additional entity value of the entity stored in association with an additional attribute value;
in the data:
the entity value and the attribute value are stored in association with a time point in a row of a data table; and
the additional entity value and the additional attribute value are stored in association with the time point in another row of the data table; and
in the further modified data, the attribute value and the additional attribute value are stored in a given row of a modified data table, the given row further containing the time point, the entity value, and the additional entity value.

16. A non-transitory computer-readable storage medium comprising instructions executable by a processor, the instructions to cause the processor to:
access data comprising an entity value of an entity stored in association with an attribute value of an attribute of the entity;
generate modified data by replacing in the data the entity value with an entity value identifier and the attribute value with an attribute value identifier, the entity value identifier and the attribute value identifier that are incrementable;
generate transformed data by applying a transformation to the modified data; and
output further modified data by replacing in the transformed data the entity value identifier with the entity value and the attribute value identifier with the attribute value.

17. The non-transitory computer-readable storage medium of claim 16, wherein the instructions further cause the processor to:
before the modified data is generated, store the entity value identifier in association with the entity value and the attribute value identifier in association with the attribute value.

18. The non-transitory computer-readable storage medium of claim 16, wherein:
to generate the modified data, the instructions further cause the processor to:
replace an additional unique entity value with a next incremented entity value identifier; and
replace an additional unique attribute value with a next incremented attribute value identifier.

19. The non-transitory computer-readable storage medium of claim 16, wherein the entity value identifier and the attribute value identifier comprise natural numbers.

20. The non-transitory computer-readable storage medium of claim 16, wherein:
the data comprises the entity value and the attribute value stored in association with a latest time value;
the data further comprises a further entity value and a corresponding further attribute value stored in associate with a further latest time value, the further latest time value being later than the latest time value by a data collection time point; and
to generate the transformed data, the instructions cause the processor to:
for the data collection time point, store an imputed entity value identifier in association with an imputed attribute value identifier, the imputed entity value identifier associated with an imputed entity value and the imputed attribute value identifier associated with an imputed attribute value corresponding to the imputed entity value.
